(19) United States
(12) Patent Application Publication
(10) Pub. No.: US 2018/0023544 A1
(43) Pub. Date: Jan. 25, 2018

(54) A WIND TURBINE WITH A ROTOR COMPRISING A HOLLOW KING PIN

(71) Applicant: Vestas Wind Systems A/S, Aarhus N. (DK)

(72) Inventors: Torben Ladegaard Baun, Skødstrup (DK); Henrik Kudsk, Harlev J (DK)

(21) Appl. No.: 15/552,368

(22) PCT Filed: Mar. 18, 2016
(86) PCT No.: PCT/DK2016/050078

§ 371 Date: Aug. 21, 2017

(30) Foreign Application Priority Data
Mar. 30, 2015 (DK) PA 2015 70185

(51) Int. Cl. F03D 1/02; F03D 9/25; F16H 7/02; F03D 15/00; F03D 80/80; F03D 7/02; F03D 13/20

(52) U.S. Cl. CPC F03D 1/02; F03D 7/0204; F03D 9/25; F03D 13/22; F03D 15/00; F03D 80/82; F16H 7/02; F05B 2260/4021

(57) ABSTRACT

A wind turbine (11) comprising a tower structure (12, 13) and two or more rotors (1). Each rotor (1) comprises a hollow king pin (2) and a hub (4) carrying one or more rotor blades (14). The hollow king pin (2) is formed in a single cylindrical piece, and is mounted on the tower structure (12, 13). The hub (4) is rotatably mounted on the hollow cylindrical king pin (2). A generator (6) is operationally coupled to the hub (4) in such a manner that rotational movements of the hub (4) are transferred to the generator (6). The tower structure comprises a main tower part (12) being anchored, at a lower part, to a foundation structure, and at least two arms (13), each arm (13) extending away from the main tower part (12) along a direction having a horizontal component. Each arm (13) carries at least one rotor (1).

### FIELD OF THE INVENTION

The present invention relates to a wind turbine comprising two or more rotors, each rotor comprising a hollow cylindrical king pin.

### BACKGROUND OF THE INVENTION

Wind turbines normally comprise one or more rotors, each rotor comprising a hub carrying one or more wind turbine blades. The wind acts on the wind turbine blades, thereby causing the hub to rotate. The rotational movements of the hub are transferred to a generator, e.g. via a gear arrangement. In the generator, electrical energy is generated, which may be supplied to a power grid.

Wind turbines comprising two or more rotors are sometimes referred to as multirotor wind turbines. In multirotor wind turbines a given nominal output power is obtained by means of two or more rotors, each producing an output power which is smaller than the desired output power of the wind turbine, instead of by means of one large rotor.

In some wind turbines, the hub is mounted rotatably on a king pin. In this case the king pin is often made from two or more parts being assembled, e.g. by means of one or more flange connections. The flange connections allow the rotor to be detached from the rest of the wind turbine. However, the flange connections add to the weight and the total manufacturing costs of the wind turbine.

WO 2011/120720 A1 discloses a wind turbine comprising a hub carrying one or more blades. The hub is rotatably mounted on a frame comprising two parts being assembled via a flange connection.

### DESCRIPTION OF THE INVENTION

It is an object of embodiments of the invention to provide a multirotor wind turbine comprising a hollow king pin, the wind turbine having a reduced weight as compared to prior art wind turbines.

It is a further object of embodiments of the invention to provide a multirotor wind turbine comprising a hollow king pin, in which the manufacturing costs are reduced as compared to prior art wind turbines.

It is an even further object of embodiments of the invention to provide a multirotor wind turbine in which the rotors have a simple design.

It is an even further object of embodiments of the invention to provide a multirotor wind turbine in which the rotors can be easily mounted on and/or dismounted from a tower structure of the wind turbine.

The invention provides a wind turbine comprising:
a tower structure, the tower structure comprising:
   a main tower part being anchored, at a lower part, to a foundation structure, the main tower part extending along a substantially vertical direction, and
   at least two arms, each arm extending away from the main tower part along a direction having a horizontal component,
two or more rotors, each rotor comprising:
   a hollow king pin formed in a single cylindrical piece, the hollow cylindrical king pin being mounted on the tower structure,
   a hub carrying one or more rotor blades, the hub being rotatably mounted on the hollow cylindrical king pin, and
   a generator being operationally coupled to the hub in such a manner that rotational movements of the hub are transferred to the generator,

wherein each arm of the tower structure carries at least one rotor.

The wind turbine of the invention comprises a tower structure carrying two or more rotors.

Accordingly, the wind turbine is a multirotor wind turbine. In multirotor wind turbines a given nominal output power is obtained by means of two or more rotors, each producing an output power which is smaller than the desired output power of the wind turbine, instead of by means of one large rotor. Thereby the weight of each of the rotors is lower than the weight of a large rotor designed for producing the desired output power. Accordingly, the locally acting loads on various parts of the wind turbine, including the rotors themselves, are reduced as compared to the loads introduced in a wind turbine comprising only one rotor. However, the total weight of the two or more rotors may be higher than the weight of a single rotor designed for producing the desired output power, and therefore it is very desirable to minimise the weight of the rotors of a multirotor wind turbine.

Each rotor comprises a hollow king pin, a hub carrying one or more rotor blades and a generator.

The hollow king pin is formed in a single cylindrical piece. Thus, the hollow king pin does not comprise any flange connections. Thereby the total weight of the rotor is reduced, resulting in a reduction of the manufacturing costs of the wind turbine. This is particularly an advantage in the case that the wind turbine is a multirotor wind turbine, because it is very desirable to minimise the weight of the rotors in this case, as described above.

The hollow cylindrical king pin is mounted on the tower structure. Thus, the rotor is mounted on the tower structure via the hollow cylindrical king pin.

The hub is rotatably mounted on the hollow cylindrical king pin. Thus, when the wind acts on the wind turbine blades, the hub rotates relative to the hollow cylindrical king pin. The rotational movements of the hub are transferred to the generator, which is operationally coupled to the hub. Thereby electrical power is generated, essentially in the manner described above.

Due to the hollow cylindrical king pin of the rotors of the wind turbine according to the present invention, the design of the rotors is very simple, and it is easy and cost effective to manufacture the rotors. Furthermore, since the king pin is in the form of a single cylindrical part, it can be made from a standard pipe or the like. Thereby it is not necessary to provide a specially manufactured shaft for the rotor. This reduces the manufacturing costs and makes it possible to manufacture the rotor in regions where special parts are difficult to obtain and/or where expertise and/or industry within manufacturing of such special parts is not available.

Furthermore, this design of the rotors makes it easy to mount and dismount the rotors on/from the tower structure.

The hollow cylindrical king pin may, e.g., be made from cast iron, forged steel or hot rolled steel.

The tower structure comprises a main tower part and at least two arms.

The main tower part is anchored, at a lower part, to a foundation structure. Furthermore, the main tower part extends along a substantially vertical direction. Thus, the main tower part resembles a traditional wind turbine tower for a single rotor wind turbine.

Each of the arms of the tower structure extends away from the main tower part along a direction having a horizontal component. The arms may extend away from the main tower part along a substantially horizontal direction. In this case the arms extend substantially perpendicularly to the vertically arranged main tower part. As an alternative, the arms may extend away from the main tower part along a direction which has a horizontal component as well as a vertical component. In this case the arms extend away from the main tower part at an angle with respect to the main tower part which differs from 90°. The angle defined between the arms and the main tower part may advantageously be between 45° and 90°.

In any event, since the arms of the tower structure extend away from the main tower part along a direction having a horizontal component, they do not extend parallel to the vertical main tower part, but instead at an angle with respect to the main tower part.

The arms may be in the form of trusses, beams, systems of beams, lattice structures, etc. Furthermore, the arms may not necessarily be linear structures, but they may have a rounded or curved shape.

Thus, the tower structure comprises a substantially vertical main part, and at least two arms extending therefrom in a non-vertical direction.

Furthermore, the rotors are mounted on the tower structure in such a manner that each arm of the tower structure carries at least one rotor. Accordingly, the loads arising from the weight of at least some of the rotors is applied to the arms of the tower structure, and transferred to the main tower part, via the arms. The rotors can easily be mounted on or dismounted from the arms, via the hollow cylindrical king pins. Since the rotors are mounted on the arms, it is particularly important that the weight of the rotors is minimised, because this reduces the loads introduced in the arms as well as the loads which must be transferred from the arms to the tower structure.

It is not ruled out that one or more of the rotors are mounted directly on or carried by the main tower part, as long as at least some of the rotors are carried by the arms of the tower structure.

The hollow cylindrical king pin of at least one rotor may be mounted on a lower part of an arm of the tower structure. Since the arms of the tower structure extend away from the main tower part along a non-vertical direction, the main tower part is not arranged beneath the arms. Accordingly, when a rotor is mounted on a lower part of an arm of the tower structure, neither the arm, nor the main tower part will block the way between the rotor and the ground. Thereby, positioning the rotor in this manner allows it to be hoisted to its mounted position or lowered to the ground, directly, and without the need for large cranes or the like. This makes it very easy and cost effective to erect the wind turbine and to replace or perform repair work on the rotor. This is a great advantage.

The hollow cylindrical king pin of each of the rotors may be mounted directly on an arm of the tower structure, and the wind turbine may further comprise a yawing mechanism arranged between the main tower part and a part of the tower structure comprising the arms.

According to this embodiment, all of the rotors mounted on the arms of the tower structure are directed towards the wind simultaneously by operating the yawing mechanism. However, each of the rotors is fixedly mounted on the tower structure, via the hollow cylindrical king pins, in the sense that no yawing operation takes place between the tower structure and a given rotor.

As an alternative, the hollow cylindrical king pin of at least one of the rotors may be mounted on the tower structure via a yawing mechanism.

The hollow cylindrical king pin may extend behind the tower structure along a direction facing the wind. According to this embodiment, a part of the hollow cylindrical king pin which is arranged opposite to a position where the hub is mounted, extends beyond the tower structure.

The hollow cylindrical king pin may have a substantially uniform wall thickness. This makes it easy to manufacture the hollow cylindrical king pin, because it can simply be manufactured as a regular cylinder. It should be noted that it is not ruled out that the hollow cylindrical king pin undergoes machining during manufacturing. In this case the machining may result in variations in the wall thickness being introduced, even though the wall thickness was uniform prior to the machining.

At least one of the rotors may comprise a gear arrangement arranged to transfer rotational movements of the hub to rotational movements of a rotating shaft connected to the generator. According to this embodiment, the rotational speed of the rotating movements will normally be increased by means of the gear arrangement.

At least part of the rotating shaft may be arranged inside the hollow cylindrical king pin. According to this embodiment, the gear arrangement may be arranged at one end of the hollow cylindrical king pin, and the generator may be arranged at an opposite end of the hollow cylindrical king pin. The gear arrangement and the generator may then be interconnected by means of the rotating shaft, through the interior of the hollow cylindrical king pin.

The gear arrangement may comprise a number of pulleys and a number of belts interconnecting the pulleys in order to transfer rotational movements between the pulleys, thereby transferring rotational movements from the hub to the rotating shaft. Thus, according to this embodiment, the gear arrangement is in the form of a belt drive. This is an advantage, since the weight of a belt drive is typically lower than the weight of a corresponding gear arrangement using intermeshing toothed gear wheels. Thereby the total weight of the rotor is further reduced.

In the present context the term ‘pulley’ should be interpreted to mean a relatively flat object, having a substantially circular shape. In the present context the term ‘belt’ should be interpreted to mean an endless structure, forming a flexible ring.

The gear arrangement may comprise:
a primary pulley being rotationally decoupled from the hub,
two or more planetary pulleys, each planetary pulley being mounted on the hub, thereby rotating along with the hub, and each planetary pulley being provided with a planetary shaft, each planetary pulley being arranged to perform rotational movements about its planetary shaft, and
a centre pulley being connected to the rotating shaft,

wherein at last one belt may interconnect the primary pulley to each of the planetary shafts, and at least one belt may interconnect each of the planetary pulleys to the centre pulley.

According to this embodiment, the pulleys of the gear arrangement are mounted in a planetary manner with a primary pulley, two or more planetary pulleys and a centre pulley. The primary pulley is rotationally decoupled from the hub, i.e. the primary pulley does not rotate along with the hub when the wind acts on the rotor blade(s). The primary pulley may be fixedly mounted relative to the hollow cylindrical king pin, or it may be arranged to perform rotational movements relative to the hollow cylindrical king pin, as long as these rotational movements are not following the rotational movements of the hub. Accordingly, when the hub rotates, a relative rotational movement occurs between the hub and the primary pulley.

Each of the planetary pulleys is mounted on the hub, i.e. the planetary pulleys rotate along with the hub when the hub rotates due to the wind acting on the rotor blade(s). Thereby a relative rotational movement between the primary pulley and the planetary pulleys is also provided when the hub rotates.

Each of the planetary pulleys is further provided with a planetary shaft, and each planetary pulley is arranged to perform rotational movements about its planetary shaft. Thus, apart from rotating along with the hub, each planetary pulley is also capable of performing individual rotational movements about the corresponding planetary shaft.

The centre pulley is connected to the rotating shaft. Thereby rotational movements of the centre pulley are directly transferred to the rotating shaft.

At least one belt interconnects the primary pulley to each of the planetary shafts. Thereby the relative rotational movement between the primary pulley and the planetary pulleys drives rotational movements of each of the planetary pulleys about their respective planetary shafts, via the at least one belt. One belt may interconnect the primary pulley and a given planetary shaft. In this case the belts of the respective planetary shafts may be arranged side by side on the primary pulley. As an alternative, the primary pulley and a given planetary shaft may be interconnected by two of more belts, the belts being arranged side by side on the primary pulley, as well as on the planetary shaft.

Furthermore, at least one belt interconnects each of the planetary pulleys to the centre pulley. Thereby the rotational movements of the planetary pulleys, about their respective planetary shafts, drives a rotational movement of the centre pulley, and thereby of the rotating shaft, via the at least one belt. As described above, a single belt or two or more belts arranged side by side may be applied.

The gear arrangement may be arranged in front of the hub along a direction facing the wind. According to this embodiment, the gear arrangement and the hub are arranged relative to each other in such a manner that, seen in a direction from the tower structure, the hub is first encountered, and subsequently the gear arrangement. In the case that the gear arrangement is in the form of a belt drive, this allows the belts of the gear arrangement to be easily inspected and replaced, because they are readily accessible, from the front of the wind turbine. For instance, the belts of the gear arrangement can be replaced without dismantling either the generator or the hub.

As an alternative, the gear arrangement may be arranged behind the hollow cylindrical king pin along a direction facing the wind. According to this embodiment, the hub, the hollow cylindrical king pin and the gear arrangement are arranged relative to each other in such a manner that, seen in the direction defined above, the gear arrangement is first encountered, then the hollow cylindrical king pin, and finally the hub. The gear arrangement may be mounted directly onto an end part of the hollow cylindrical king pin, e.g. an end part extending beyond the tower structure.

The generator may be bolted onto an end of the hollow cylindrical king pin, via one or more threaded holes formed in a wall of the hollow cylindrical king pin, said one or more threaded holes extending substantially along an axial direction defined by the hollow cylindrical king pin. According to this embodiment, the generator can be mounted directly on the hollow cylindrical king pin without the use of a flange connection. This even further reduces the weight of the rotor.

The rotating shaft may be connected to the generator at a front end of the generator. As an alternative, the rotating shaft may extend through the generator, and be connected to the generator at a rear end thereof.

### BRIEF DESCRIPTION OF THE DRAWINGS

The invention will now be described in further detail with reference to the accompanying drawings in which

FIG. 1 is a side view of a rotor for a wind turbine according to a first embodiment of the invention,

FIG. 2 is a side view of a rotor for a wind turbine according to a second embodiment of the invention,

FIG. 3 is a side view of a rotor for a wind turbine according to a third embodiment of the invention,

FIG. 4 is a front view of a wind turbine according to a fourth embodiment of the invention, and

FIGS. 5 and 6 illustrate a rotor for a wind turbine according to a fifth embodiment of the invention.

### DETAILED DESCRIPTION OF THE DRAWINGS

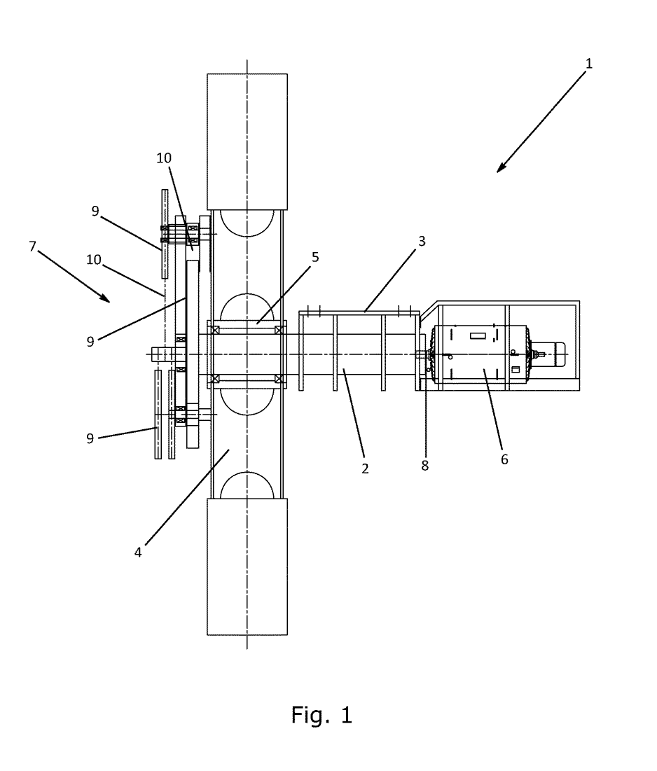

FIG. 1 is a side view of a rotor 1 for a wind turbine according to a first embodiment of the invention. The rotor 1 comprises a hollow king pin 2 formed in a single cylindrical piece. The rotor 1 can be mounted on a part of a tower structure (not shown) of the wind turbine, via the hollow cylindrical king pin 2 and a mounting frame 3. Accordingly, the hollow cylindrical king pin 2 is not able to rotate with respect to the tower structure.

A hub 4 is mounted rotatably on the hollow cylindrical king pin 2, via a bearing arrangement 5. Accordingly, the hub 4 is able to perform rotational movements with respect to the hollow cylindrical king pin 2. The hub 4 carries a number of rotor blades (not shown), and when the wind acts on the rotor blades, the hub 4 is caused to rotate with respect to the hollow cylindrical king pin 2.

The rotational movements of the hub 4 are transferred to a generator 6, via a gear arrangement 7 and a rotating shaft 8, which extends through the hollow cylindrical king pin 2. Thereby electricity is generated, essentially as described above.

The gear arrangement 7 comprises a number of pulleys 9 and a number of belts 10 interconnecting the pulleys 9 in order to transfer rotational movements between the pulleys 9. Thus, the gear arrangement 7 is in the form of a belt drive.

The gear arrangement 7 is arranged in front of the hub 4, along a direction facing the wind, i.e. as seen in the direction of the incoming wind. Thereby the pulleys 9 and the belts 10 are readily accessible, e.g. for the purpose of performing maintenance on the gear arrangement 7. For instance, this allows the belts 10 of the gear arrangement 7 to be easily repaired or replaced, without having to dismantle the hub 4 or the generator 6.

The generator 6 is arranged behind the hollow cylindrical king pin 2 along the direction facing the wind. Accordingly, the generator 6 is arranged at an end of the hollow cylindrical king pin 2 which is opposite to an end where the hub 4 and the gear arrangement 7 are arranged. The generator 6 may be bolted directly onto the hollow cylindrical king pin 2, via threaded holes formed in the wall of the hollow cylindrical king pin 2, the holes extending in parallel to the axis of the cylinder defined by the hollow cylindrical king pin 2.

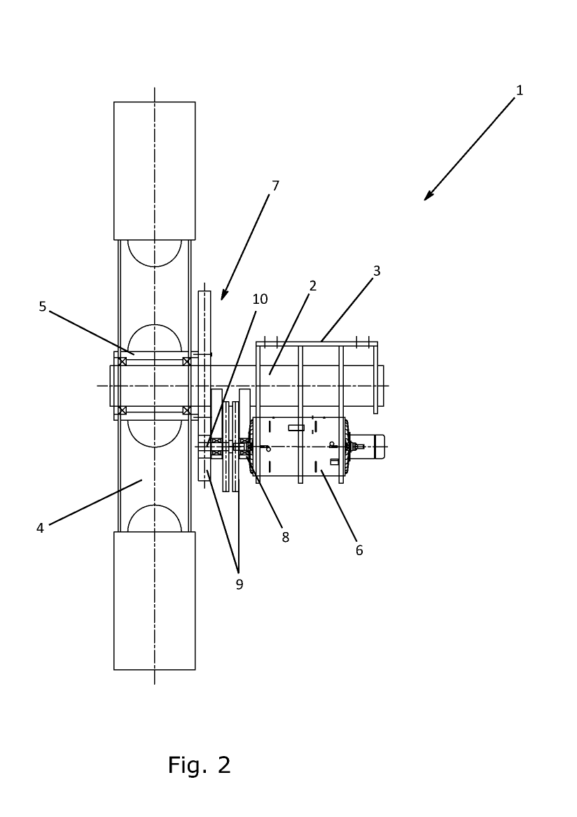

FIG. 2 is a side view of a rotor 1 for a wind turbine according to a second embodiment of the invention. The rotor 1 of FIG. 2 is very similar to the rotor 1 of FIG. 1, and it will therefore not be described in detail here.

In the rotor 1 of FIG. 2, the rotating shaft 8 does not extend through the hollow cylindrical king pin 2, but is instead arranged in parallel to and below the hollow cylindrical king pin 2. Furthermore, the gear arrangement 7 is arranged immediately behind the hub 4. The generator 6 is also arranged below the hollow cylindrical king pin 2. This provides a more compact rotor design than the design of the rotor 1 of FIG. 1.

The rotor 1 of FIG. 2 is very suitable for being mounted below a part of the tower structure, for instance on a lower side of an arm of the tower structure, e.g. suspended from a part of the tower structure, because the generator 6 and the rotating shaft 8 are arranged below the hollow cylindrical king pin 2. In this case the generator 6 and the rotating shaft 8 are arranged on an opposite side of the hollow cylindrical king pin 2 as compared to the mounting frame 3, and the generator 6 and the rotating shaft 8 are thereby not in the way when the mounting frame 3 is attached to the tower structure.

It should be noted that, as an alternative, the generator 6 could be arranged above the hollow cylindrical king pin 2, thereby allowing the rotor 1 to be mounted above a part of the tower structure, e.g. resting on a part of the tower structure.

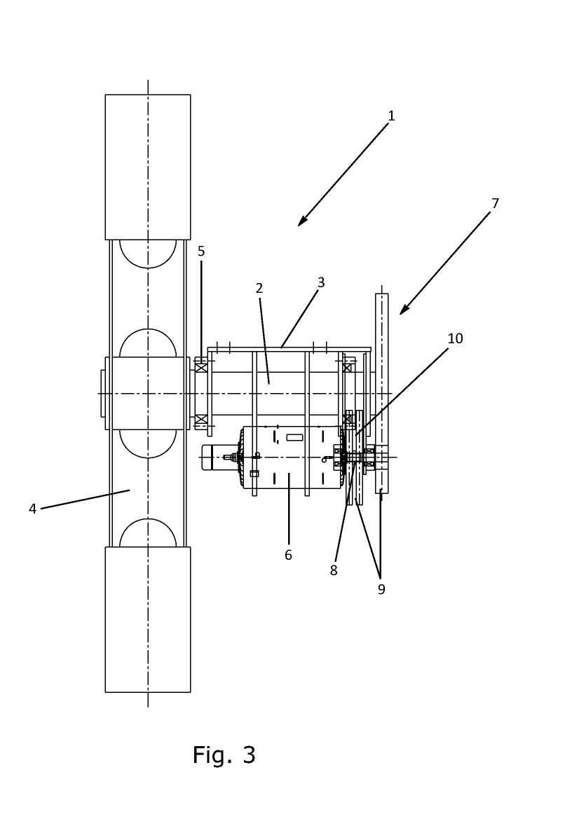

FIG. 3 is a side view of a rotor 1 for a wind turbine according to a third embodiment of the invention. The rotor 1 of FIG. 3 is very similar to the rotors 1 of FIGS. 1 and 2, and it will therefore not be described in detail here.

In the rotor 1 of FIG. 3, the generator 6 and the rotating shaft 8 are arranged below the hollow cylindrical king pin 2, similar to the embodiment of FIG. 2, and thereby the rotor 1 is very suitable for being mounted below a part of the tower structure, e.g. suspended from a part of the tower structure. However, in the rotor 1 of FIG. 3, the gear arrangement 7 is arranged behind the hollow cylindrical king pin 2. Thereby the gear arrangement 7 is readily accessible, similarly to the situation described above with reference to FIG. 1.

As described above, the generator 6 and the rotating shaft 8 could, as an alternative, be arranged above the hollow cylindrical king pin 2, thereby allowing the rotor 1 to be mounted above a part of the tower structure, e.g. resting on a part of the tower structure.

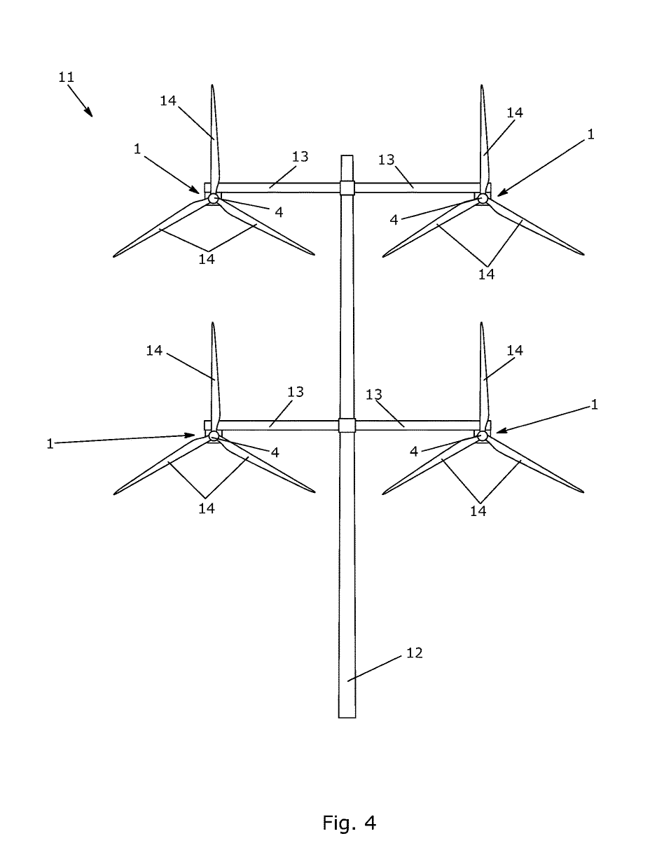

FIG. 4 is a front view of a wind turbine 11 according to a fourth embodiment of the invention. The wind turbine comprises a tower structure with a main tower part 12 and four arms 13, each extending substantially horizontally away from the main tower part 12.

Each of the arms 13 carries a rotor 1, each rotor 1 comprising a hub 4 carrying three rotor blades 14. Accordingly, the wind turbine 11 is of a multirotor kind. The rotors 1 could, e.g., be of the kind illustrated in one of FIGS. 1-3.

The four arms 13 are arranged in such a manner that two of them are mounted on the main tower part 12 at a first height, and the other two are mounted on the main tower part 12 at a second, higher height. Two arms 13 mounted on the main tower part 12 at the same height extend away from the main tower part 12 along substantially opposite directions. Accordingly, the arms 13 are arranged symmetrically with respect to the main tower part 12. Thereby the loads introduced in the tower structure by the arms 13, including the loads introduced by the weight of the rotors 1 carried by the arms 13, are balanced.

The rotors 1 are mounted below the arms 13, i.e. suspended from the arms 13. This allows the rotors 1 to be readily hoisted into position on the arms 13 of the tower structure, or lowered to the ground, without the need for large cranes or the like. Thereby erecting the wind turbine 11, decommissioning the wind turbine 11 and/or replacing a rotor 1 is very easy and cost effective.

The arms 13 may be mounted on the main tower part 12 in a pivotal or rotational manner, allowing the upper and lower arms 13 to be rotated relative to each other, thereby allowing the rotors 1 mounted on the upper arms 13 to be moved away from a position directly above the rotors 1 being mounted on the lower arms 13. This will allow the rotors 1 mounted on the upper arms 13 to be lowered to the ground without colliding with the rotors 1 mounted on the lower arms 13.

It should be noted that the rotors 1 could, alternatively, be mounted above the arms 13 of the tower structure. As another alternative, the wind turbine could be of a single rotor type, i.e. the wind turbine may only comprise a single rotor, mounted on a tower structure, e.g. on top of a conventional tower.

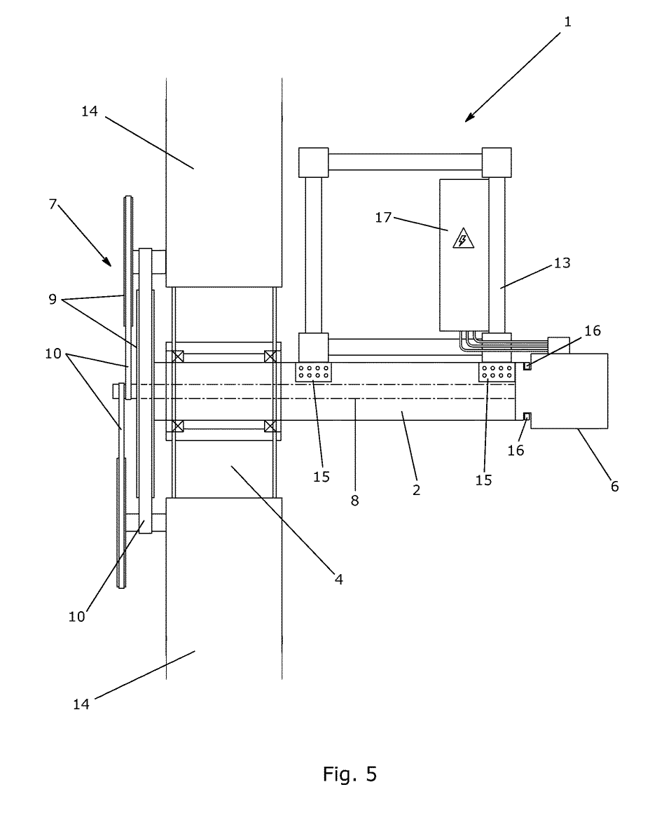

FIG. 5 is a side view of a rotor 1 for a wind turbine according to a fifth embodiment of the invention. Similarly to the rotor 1 illustrated in FIG. 1, the rotor 1 of FIG. 5 comprises a hollow cylindrical king pin 2, and a hub 4 rotatably mounted on the hollow cylindrical king pin 2, the hub 4 carrying a number of rotor blades 14, two of which are visible. The rotor 1 further comprises a gear arrangement 7, comprising a number of pulleys 9 and belts 10, the gear arrangement 7 being arranged in front of the hub 4, along a direction facing the wind. A rotating shaft 8 interconnects the gear arrangement 7 and a generator 6 arranged behind the hollow cylindrical king pin 2, i.e. opposite with respect to the hub 4 and the gear arrangement 7. The rotating shaft 8 extends through the hollow cylindrical king pin 2.

The hollow cylindrical king pin 2 is mounted on an arm 13 of a tower structure via brackets 15 being bolted onto the hollow cylindrical king pin 2. The hollow cylindrical king pin 2 is mounted on a lower side of the arm 13, i.e. suspended from the arm 13.

The generator 6 is bolted onto an end part of the hollow cylindrical king pin 2 by means of bolts 16.

Electrical components 17 are mounted on the arm 13 of the tower structure, the electrical components 17 being electrically connected to the generator 6.

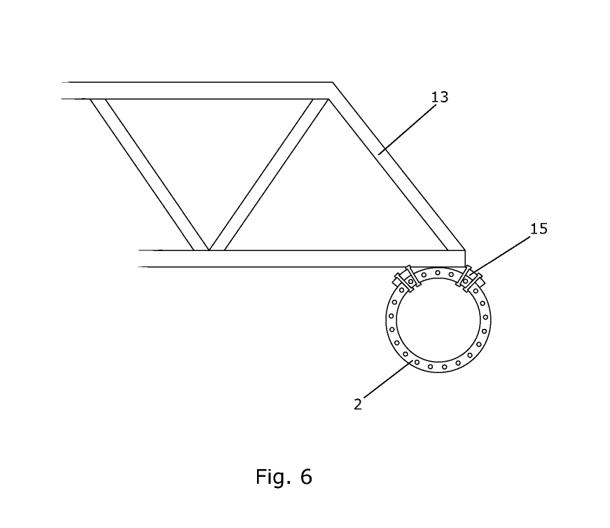

FIG. 6 is a cross sectional view of the rotor 1 of FIG. 5. It can be seen how the hollow cylindrical king pin 2 is mounted on the arm 13 of the tower structure via the bracket 15.

1. A wind turbine comprising:
a tower structure, the tower structure comprising:
a main tower part being anchored, at a lower part, to a foundation structure, the main tower part extending along a substantially vertical direction, and
at least two arms, each arm extending away from the main tower part along a direction having a horizontal component,
two or more rotors, each rotor comprising:
a hollow king pin formed in a single cylindrical piece, the hollow cylindrical king pin being mounted on the tower structure,
a hub carrying one or more rotor blades, the hub being rotatably mounted on the hollow cylindrical king pin, and
a generator being operationally coupled to the hub in such a manner that rotational movements of the hub are transferred to the generator wherein each arm of the tower structure carries at least one rotor.

2. The wind turbine according to claim 1, wherein the hollow cylindrical king pin of at least one rotor is mounted on a lower part of an arm of the tower structure.

3. The wind turbine according to claim 1, wherein the hollow cylindrical king pin of each of the rotors is mounted directly on an arm of the tower structure, and wherein the wind turbine further comprises a yawing mechanism arranged between the main tower part and a part of the tower structure comprising the arms.

4. The wind turbine according to claim 1, wherein the hollow cylindrical king pin extends behind the tower structure along a direction facing the wind.

5. The wind turbine according to claim 1, wherein the hollow cylindrical king pin has a substantially uniform wall thickness.

6. The wind turbine according to claim 1, wherein at least one of the rotors comprises a gear arrangement arranged to transfer rotational movements of the hub to rotational movements of a rotating shaft connected to the generator.

7. The wind turbine according to claim 6, wherein at least part of the rotating shaft is arranged inside the hollow cylindrical king pin.

8. The wind turbine according to claim 6, wherein the gear arrangement comprises a number of pulleys and a number of belts interconnecting the pulleys in order to transfer rotational movements between the pulleys, thereby transferring rotational movements from the hub to the rotating shaft.

9. The wind turbine according to claim 8, wherein the gear arrangement comprises:
a primary pulley being rotationally decoupled from the hub,
two or more planetary pulleys, each planetary pulley being mounted on the hub, thereby rotating along with the hub, and each planetary pulley being provided with a planetary shaft, each planetary pulley being arranged to perform rotational movements about its planetary shaft, and
a centre pulley being connected to the rotating shaft, wherein at last one belt interconnects the primary pulley to each of the planetary shafts, and at least one belt interconnects each of the planetary pulleys to the centre pulley.

10. The wind turbine according to claim 6, wherein the gear arrangement is arranged in front of the hub along a direction facing the wind.

11. The wind turbine according to claim 6, wherein the gear arrangement is arranged behind the hollow cylindrical king pin along a direction facing the wind.

12. The wind turbine according to claim 1, wherein the generator is bolted onto an end of the hollow cylindrical king pin, via one or more threaded holes formed in a wall of the hollow cylindrical king pin, said one or more threaded holes extending substantially along an axial direction defined by the hollow cylindrical king pin.
